(19) United States
(12) Patent Application Publication
(10) Pub. No.: US 2003/0224149 A1
(43) Pub. Date: Dec. 4, 2003

(54) Image recording medium

(76) Inventor: Yasuyuki Takada, Yamagata (JP)

Correspondence Address: 3M INNOVATIVE PROPERTIES COMPANY, PO BOX 33427, ST. PAUL, MN, 55133-3427, US

(21) Appl. No.: 10/257,163

(22) PCT Filed: May 30, 2001
(86) PCT No.: PCT/US01/17395

(51) Int. Cl. B32B 3/30

(52) U.S. Cl. 428/195.1; 428/32.1; 428/202

(57) ABSTRACT

An image recording medium comprising a support having two major surfaces, an ink-receptive layer disposed on the first major surface of said support, and an adhesive layer disposed on the second major surface of said support, wherein the support is a porous body having gas permeable fine pores, a plurality of grooves capable of communicating with the exterior upon contacting with an adherend are provided on the adhering surface of said adhesive layer, the adhering surface being a surface opposite the surface contacting with the support and put into contact with the adherend, and said grooves are formed to satisfy the relationship between the depth D μm measured from the adhering surface and the thickness T (μm) of the adhesive layer, represented by the following formula: 0≦T−D≦10, provided that D≧16 μm.

### FIELD OF INVENTION

The present invention relates to an image recording medium which can record an ink image by a printing method such as ink jet printing and which is adhered in the state of having a recorded ink image to an adherend on use. In particular, the present invention relates to an image recording medium which can be effectively prevented from occurrence of swelling due to water imbibed from the edge of the medium during the use, particularly even on use outdoors.

### BACKGROUND OF THE INVENTION

Ink-jet printing is now a well-known technology. In recent years, printers for recording a large image in a broad format are commercially available and a larger article such as color poster can be printed. A conventional image recording medium for ink jet recording is shown in FIG. 1. This image recording medium 11 comprises a support 12, an ink-receptive layer 13 disposed on one major surface (usually front surface) of the support, and an adhesive layer 14 disposed on another major surface (usually back surface) of the support. On the ink-receptive layer, a printing layer 15 is provided by printing and then an. over-laminate film 18 comprising a pressure-sensitive adhesive layer 16 and a transparent film 17 is provided thereon so as to protect the printing layer. This sheet having recorded thereon an ink image is used by adhering it to an adherend such as marker board, sign-board or vehicle body.

Thus, the large format ink jet recording sheet is used outdoors in many cases but conventional ink jet receptors have a problem in that the image becomes unclear with the passing of time, for example, undergoes occurrence of discoloration or change in the image quality. With an attempt to improve the durability of the image on the printing layer in these image recording mediums for ink jet recording against the change into an unclear image, various image recording mediums have been proposed.

Such an image recording medium is disclosed in Japanese Unexamined National Patent Publication (Kohyo) No. 10-505800. The image recording medium disclosed comprises a substrate, an ink-receptive layer contacting with the front surface of the substrate, and an adhesive layer disposed on the back surface of the substrate. The ink-receptive layer comprises at least one protective penetration layer having a predetermined composition and at least one image-receiving layer (ink-fixing layer) having another predetermined composition. The protective penetration layer and the image-receiving layer each contains a particulate dispersion such as corn starch or denatured corn starch. For the base material, for example, a porous film comprising gas permeable fine pores may be used. The porous film is advantageous for the printing using an aqueous ink. The patent publication also discloses a technique of forming an image by printing on the surface of the ink-receptive layer and then covering it with a transparent protective layer. As a specific example of the porous film, Teslin™ film, a porous stretched resin film produced by PPG Industry K.K., is disclosed.

Use of such a support comprising a porous film is also disclosed, for example, in International Patent Publication WO99-03685. In this patent publication, a surfactant and a multivalent metal salt are contained in gas permeable micropores of the porous film support. The multivalent metal salt is fixed within the micropore by, after hydrophilizing the inner wall (inner surface) of micropores of the support with a surfactant, coating a solution containing a multivalent metal salt thereon. In this case, the ink-receptive surface is the surface of the support and printing ink is fixed onto this support surface to record an image. The multivalent metal salt functions as a coagulant and acts to elevate the water resistance of the ink image.

U.S. Pat. No. 5,605,750 discloses an image recording medium, in which a porous support having dispersed therein water-insoluble filler particles (e.g., silica) is used and an ink-receptive layer comprising porous pseudo-boehmite is disposed on the surface of the porous support. On this medium, by virtue of the ink-receptive layer provided on the support, an image favored with high coloring property can be easily formed.

This ink-receptive layer disposed on the support may also be a layer containing a polymer. In this case, the receptive layer is, for example, a layer containing a polymer and an inorganic pigment. The inorganic pigment is used for imparting porosity to the ink-receptive layer and usually, water-insoluble particle such as porous synthetic silica and alumina hydrosol is used. The resin is, for example, a water-soluble polymer or a cation-modified polymer (e.g., polyurethane). In particular, the cation-modified polymer advantageously elevates the ink fixing property (ink setting property) and facilitates the formation of an image favored with high coloring property and high water resistance.

As such, in order to improve the coloring property, image quality and water resistance of an image, it is advantageous to provide an ink-receptive layer having a predetermined composition in addition to a porous support. Furthermore, in order to increase the ink drying (fast-drying) property, it is advantageous not to impair the gas permeability, namely, porosity of the ink-receptive layer. However, even if the porosity of the ink-receptive layer is elevated as much as possible, the coloring components in the ink, particularly a pigment, migrate into pores inside the ink-receptive layer or support, as a result, the drying property after the printing is liable to decrease.

The adhesive layer used in conventional image recording mediums is the same as normal adhesive sheet or film and an adhesive layer particularly exclusive for image recording mediums is not known. The adhesive layer used in normal adhesive sheets is roughly classified into (1) an adhesive layer having a nearly flat adhering surface and (2) an adhesive layer having formed on the adhering surface thereof an asperity structure. In (2) above, the asperity structure may be effectively formed on the adhering surface by a known method disclosed in Registered Utility Model 2,587,198, International Patent Publication WO93/05123 and Japanese Unexamined Patent Publication (Kokai) No. 11-209704.

### SUMMARY OF THE INVENTION

As described in the above, an adhesive layer exclusive for image recording mediums has been heretofore not known. However, the image recording medium comprising a porous support containing gas permeable fine pores is found to suffer from occurrence of a peculiar problem, namely, reduction of field water resistance, depending on the adhesive layer selected. In an image recording medium, a laminate interface exists between support and adhesive layer or between ink-receptive layer and protective layer. In such an image recording medium, water invades the laminate interface through edges of the medium during use and the water staying on the interface is found to cause generation of swelling inside the medium to impair the appearance. The property capable of effectively preventing such appearance defect due to the residence of water is referred to as field water resistance.

In the case where a medium having thereon an image recorded using an aqueous ink by a printing method such as ink jet printing is used by adhering it to an adherend such as outdoor sign-board, a protective layer is disposed on the image to protect the image, for example, a transparent film is over-laminated. Furthermore, an edge-seal treatment is usually performed so as to prevent invasion of water through edges of the image recording medium (usually, edges of the porous support) and thereby prevent damage of the image due to water. The edge-seal treatment is performed by adhering a pressure-sensitive adhesive tape or coating a liquid resin and solidifying it.

If the edge-seal treatment is not performed, water easily is imbibed from edges of the support and migrates into the interface with another layer adjacent to the support. The water further passes through the interface and migrates to the interface between the another layer and a third layer adjacent thereto. On the other hand, if a protective layer is disposed as described above, the imbibed water cannot easily escape from the ink-receptive surface. Accordingly, if a protective layer is disposed, a relatively large amount of water is liable to stay within the medium. If the resident water is vaporized, the internal pressure inside the medium rises to generate swelling as described above. This swelling is known to occur on the interface between adhesive layer and support, between ink-receptive surface and protective layer or between adherend and adhesive layer.

Accordingly, in order to solve these problems, the object of the present invention is to provide an image recording medium comprising a porous support containing gas permeable fine pores, an ink-receptive layer and an adhesive layer, in which the adhesive layer is effectively selected so that the field water resistance can be improved and even if an edge-seal treatment is not performed, the generation of appearance defective due to the residence of water imbibed from edges of the medium can be effectively prevented during the use.

More specifically, the object of the present invention has been attained by an image recording medium comprising:

a support having two major surfaces,

an ink receptor layer disposed on the first major surface of the support, and

an adhesive layer disposed on the second major surface of the support,

wherein the support is a porous body having gas permeable fine pores,

a plurality of grooves capable of communicating with the exterior upon contacting with an adherend are provided on the adhering surface of the adhesive layer, the adhering surface being a surface opposite the surface contacting with the support and put into contact with the adherend, and

the grooves satisfy the relationship between the depth D (μm) measured from the adhering surface and the thickness T (μm) of the adhesive layer, represented by the following formula:

0≦T−D≦10, provided that D≧16 μm.

### BRIEF DESCRIPTION OF THE DRAWINGS

FIG. 1 is a schematic cross section showing the construction of a conventional image recording medium for ink jet recording.

FIG. 2 is a schematic cross section showing the construction of the image recording medium of the present invention.

FIG. 3 is a partly enlarged sectional view of an adhesive layer of a image recording medium of the present invention.

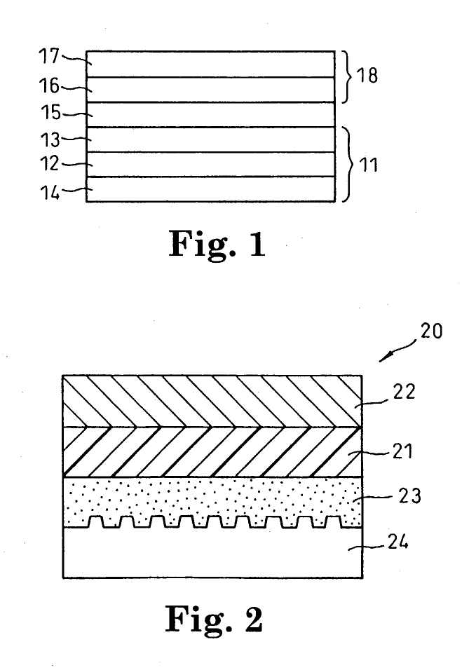

### DESCRIPTION OF REFERENCE NUMERALS

11, 20 . . . image recording medium

12, 21 . . . support

13, 22 . . . ink-receptive layer

14, 23 . . . adhesive layer

15 . . . printing layer

16 . . . pressure-sensitive adhesive layer

17 . . . transparent film

18 . . . over-laminate film

24 . . . release liner

25 . . . adhering surface

### MODE FOR CARRYING OUT THE INVENTION

One embodiment of the image recording medium of the present invention is shown in FIG. 2. The image recording medium 20 of the present invention is constructed by a support 21 having two major surfaces, an ink-receptive layer 22 disposed on the first major surface of the support and an adhesive layer 23 disposed on the second major surface of the support. The adhesive layer 23 may be covered with a release liner 24.

The support 21 is usually composed of a film or sheet containing gas permeable fine pores (hereinafter collectively referred to as “porous film”). The support is a porous body, therefore, it can quickly absorb the solvent (dispersion medium) such as water in the ink applied to the recording medium and thereby the fast drying property can be elevated. The porous film is not particularly limited as long as the above-described effect can be brought out, and those conventionally used for image recording mediums can be used. Specific examples of the material for the porous film include polyolefins such as polyethylene, polypropylene and polymethylpentene-1, polyvinyl chloride, polystyrene, a styrene-butadiene-acrylonitrile copolymer, polyamide, polymethyl methacrylate and polyester. These may be used in combination of two or more thereof. Suitable examples of the commercially available product include (trademark) Teslin resin film which is a porous stretched resin film produced by PPG Industry K.K.

The support has gas permeability because it contains gas permeable fine pores. The gas permeability specified by using Gurley permeability is usually from 10 to 3,000 seconds/100 mL, preferably from 50 to 2,500 seconds/100 mL, more preferably from 100 to 2,000 seconds/100 mL. The Gurley permeability as used herein is a value measured using a Gurley permeability tester in accordance with JIS P-8117-1980 and shown by the time necessary for air having a volume of 100 mL to pass through. The porosity of the porous film (the volume of voids occupying in the volume of the entire film) is usually from 10 to 90 vol %, preferably from 20 to 80 vol %. The pore diameter measured by vertically cutting the film in the thickness cross-sectional direction (horizontal direction of the stretched film) is usually from 0.01 to 3 μm, preferably from 0.02 to 2 μm, more preferably from 0.03 to 1 μm.

The thickness of the support as a whole is from 30 to 500 μm, preferably from 50 to 300 μm. If the thickness is excessively small, the ink drying property may decrease, whereas if it is excessively large, the recording medium may have a problem in handleability.

The support surface and the fine pore are preferably hydrophilized by a surfactant, so that the fast drying property of the printed ink image can be effectively improved. As the surfactant, any of anionic, cationic, amphoteric and nonionic surfactants may be used. Examples of the anionic surfactant which can be used include a carboxylate-base surfactant, a sulfonate-base surfactant and a phosphate-base surfactant. Examples of the cationic catalyst which can be used include an amine salt-base surfactant and a quaternary ammonium salt-base surfactant. Examples of the amphoteric surfactant which can be used include a betaine-base surfactant and a sulfobetaine-base surfactant. Examples of the nonionic surfactant which can be used include a polyoxyalkylene-base surfactant such as polyethylene glycol, a sorbitan-base surfactant and a sorbitol-base surfactant.

The hydrophilization treatment can be performed simultaneously with the formation of the ink-receptive layer by adding a surfactant to the coating solution for forming the ink-receptive layer and applying the coating solution onto the support surface. The treatment may also be performed before the formation of the receptive layer. More specifically, a liquid containing a surfactant is coated on the support surface or the support is impregnated with that liquid, thereby performing the hydrophilization treatment, thereafter, a liquid containing a polymer and a coagulant is preferably coated on the hydrophilized support surface to form the ink-receptive layer. By this method, an image recording medium favored with fast drying property can be particularly easily produced.

In the case of performing the hydrophilization treatment by coating a liquid containing a surfactant and then drying it, water or an alcohol such as ethanol is preferably used as the solvent. The surfactant concentration in the liquid containing a surfactant is usually from 1 to 30 mass %, preferably from 5 to 25 mass %. Any appropriate coating apparatus, including ordinary coaters such as bar coater, knife coater, roll coater and die coater, may be used.

The porous film may contain inorganic fine powder, if desired. Examples of the inorganic fine powder which can be used include calcium carbonate, alumina, calcined clay, silica (containing amorphous silica), diatomaceous earth, talc, titanium oxide and barium sulfate. The particle size of the fine powder is usually from 0.3 to 10 μm, preferably from 0.8 to 5 μm. In addition, other additives such as heat stabilizer, ultraviolet absorbent, dispersant, antistatic agent, antioxidant and oil (e.g., mineral oil) may be blended.

The ink-receptive layer 22 of the recording medium of the present invention preferably contains an organic polymer and a coagulant comprising a salt of a water-soluble organic or inorganic acid. Such a coagulant quickly coagulates a coloring component such as pigment on the surface of the ink-receptive layer. Therefore, the pigment or the like can be effectively prevented from migrating into pores inside the medium and the fast-drying property can be elevated. Furthermore, by containing an organic polymer in addition to the coagulant, the above-described coagulating action and the binding action of the polymer can synergistically and effectively increase the water resistance of the ink image fixed on the surface.

In the case where the polymer of the ink-receptive layer is a polar polymer having a polar functional group within the molecule, the synergistic effect of the coagulant and the polar polymer effectively enhances the aqueous ink-coagulating action. Suitable examples of the polar polymer include basic polymers such as cation-modified polyurethane and polyvinylpyrrolidone.

Examples of the organic polymer which can be used include, other than the above-described cation-modified polyurethane and the like, polyolefin, polyvinyl chloride, polyvinylidene chloride, polystyrene, styrene-butadiene-acrylonitrile copolymer, polyamide, acrylic polymer, polyester and normal (not modified) polyurethane.

As the organic or inorganic acid salt, multivalent metal salts are preferred because they have a relatively high coagulating action and provide an excellent effect of simultaneously elevating the fast-drying property and the water resistance of fixed ink image. Examples of the multivalent metal salt include aluminum, gallium, titanium zirconium, hafnium, zinc, magnesium calcium, niobium, tantalum, iron, copper, tin and cobalt, and these can be used individually or in combination of two or more thereof.

Suitable examples of the inorganic acid include sulfuric acid, nitric acid and hydrochloric acid. In the case where the organic polymer is a cation-modified polymer such as cation-modified polyurethane, an inorganic acid salt is preferred rather than an organic acid salt, because the fast-drying property and the water resistance can be effectively elevated. As the inorganic acid salt, aluminum sulfate is preferred. Although the reason therefor is not particularly elucidated, it is considered that the cation moiety of the polymer interacts with sulfate ion and aluminum ion and thereby the ink fixing force is effectively increased.

Suitable examples of the organic acid which can be used include aromatic acids such as carboxylic acid, sulfonic acid, sulfocarboxylic acid, hydroxysulfocarboxylic acid and hydroxycarboxylic acid. These acids may be used individually or in combination of two or more thereof.

The amount of the coagulant contained in the ink-receptive layer is usually from 1 to 70 parts by mass, preferably from 3 to 50 parts by mass, more preferably from 5 to 30 parts by mass, per 100 parts by mass of the organic polymer. If the amount of the coagulant is excessively small, the ink fixing force decreases and the water resistance or coloring property may be reduced, whereas if it is excessively large, blurring of the ink image may occur.

In order to elevate the porosity, the ink-receptive layer may contain an inorganic fine powder, if desired. Examples of the inorganic fine powder which can be used include calcium carbonate, alumina, calcined clay, silica (including amorphous silica), diatomaceous clay, talc, titanium oxide and barium sulfate. The particle size of the fine powder is usually from 0.3 to 10 μm, preferably from 0.8 to 5 μm. In addition, other additives such as heat stabilizer, ultraviolet absorbent, dispersant, antistatic agent and antioxidant may be blended.

The thickness of the ink-receptive layer is not particularly limited as long as the effect of the present invention is not impaired. A relatively large thickness is advantageous because the ink image can be easily prevented from blurring. From this standpoint, the thickness of the ink-receptive layer is usually from 5 to 200 μm, preferably from 10 to 100 μm.

The ink-receptive layer is formed, for example, by coating a liquid containing a coagulant and an organic polymer and then drying it. At this time, water or an alcohol is preferably used as the solvent. With respect to the coating apparatus, an ordinary coater such as bar coater, knife coater, roll coater and die coater may be used.

The water-soluble salts can be effectively increased in the coagulating action when they are ionized. Therefore, the ink applied to the surface of an image recording medium (ink-receptive layer) is preferably an ink containing water, namely, an aqueous ink. The term “water-soluble salt” as used herein means that the salt can react with water and generate an ionization seed. The solubility is, in terms of the amount dissolved in 100 g of water at 20° C., usually from 0.001 to 100 g, preferably from 0.01 to 90 g, more preferably from 0.1 to 80 g.

As described above, the adhesive layer 23 has on its adhering surface to come into contact with an adherend an asperity structure containing a plurality of grooves which can communicate with the exterior on contacting with an adherend and each has a predetermined dimension. These grooves satisfy the relationship between the depth D (μm) measured from the adhering surface and the thickness T (μm) of the adhesive layer, represented by the following formula:

0≦T−D≦10, provided that D≧16 μm

By having a groove depth D of 16 μm or more, channels communicating with the exterior can be formed between the grooves and the adherend surface (adhering surface) and the water imbibed into the inside of the medium through edges of the porous support can be prevented from staying inside the medium and allowed to escape toward the exterior (by transpiration or the like) while effectively using the channels. If the groove depth is less than 16 μm, the effective escaping of water cannot be attained. Also, if the thickness of the adhesive layer is too large with respect to the groove depth, the above-described effect decreases.

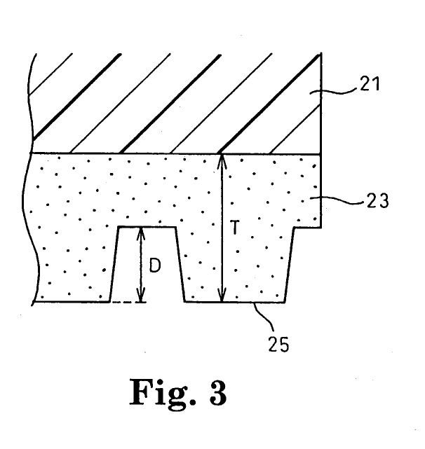

If the difference between the adhesive layer thickness and the groove depth (dimensional difference T−D) exceeds 10 μm, the thickness of the portion working out to the groove bottom (the thickness corresponds to the distance between the bottom and the support) increases and with the passing of time (namely, due to the effects of temperature and time), deformation occurs to clog the grooves and the groove depth is readily reduced. As a result, the groove depth becomes smaller than the predetermined value and the effective escaping of water may not be attained. Here, by referring to FIG. 3, it is apparent that the adhesive layer thickness T is a dimension in the thickness direction between the adhering surface 25 and the surface opposing the support 21. Incidentally, the adhering surface 25 is usually a top surface of the convex portion defining the groove, and the groove depth D is a distance (length) from the bottom of the groove to the top surface of the convex portion (adhering surface) defining the groove.

The dimension of the asperity structure may include some variation. In such case, it is preferable that the dimension of all asperity is within a given range. However, more than 80%, preferably more than 90% of asperity may satisfy the given dimension restriction. To determine such variation of dimension quantitatively, 25 to 50 convex portions and grooves are measured by using a microscope and the like.

On the other hand, if the groove depth is excessively large, the asperity of the adhesive layer is outstanding from the surface of the image recording medium adhered to an adherend and the appearance may be impaired. From these standpoints, the groove depth D is preferably from 17 to 26 μm, more preferably from 18 to 24 μm.

The thickness T of the adhesive layer may suffice as long as the above-described effects can be achieved and it is usually from 20 to 40 μm. If the adhesive layer is too thick, the effective escaping of water may not be attained and the resident water may generate swelling, whereas if the adhesive layer is too thin, water is liable to stay on the interface with the layer disposed in the upper direction than the ink-receptive surface of the support (in the direction opposite the adhesive layer) (for example, between the ink image and the protective layer), though it may vary depending on the extent of the dimensional difference T−D. While not being bound by theory, this is considered to occur because of the following reasons.

Out of layers constituting an image recording medium exclusive of the support, a softest layer, namely, a layer closest to a liquid (liquid form) is usually an adhesive layer containing an adhesive polymer. In the case where the adhesive polymer contains a pressure-sensitive adhesive polymer, the layer is particularly soft. Soft materials in general are liable to absorb a fluid (gas or liquid). Accordingly, as the mass of the adhesive polymer is larger, the adhesive layer itself is more liable to absorb water and the migration of water toward the upper direction than the ink-receptive surface of the support can be more easily controlled. In other words, if the adhesive layer is too thin, the amount of water staying on the interface with a layer disposed in the upper direction than the ink-receptive surface of the support is liable to increase. From these standpoints, the adhesive layer thickness T is preferably from 21 to 30 μm, more preferably from 22 to 27 μm. In order not to set off the asperity of the adhesive layer when observed from the medium surface after the adhering, the adhesive layer thickness T is preferably 21 μm or more, more preferably 22 μm or more.

By taking account of these, the suitable range of the dimensional difference T−D can be determined. That is, the dimensional difference T−D is preferably from 1 to 9 μm, more preferably from 2 to 7 μm.

The asperity structure on the adhesive layer hardly deforms after adhering the medium to an adherend. For example, if it contains a crosslinked polymer, the adhesive hardly deforms. If it is susceptive to deform, it deforms at most 10%. However, taking account of such deformation, the dimension of the asperity structure is defined as a dimension measured before applying the image recording medium to an adherend. That is, if the dimension of the asperity structure is within the above range, the effect of the present invention is not impaired even if the asperity structure deforms during its use.

The asperity structure on the adhesive layer can be formed by stacking the adhesive layer on a liner having on the surface thereof a structure negatively corresponding to the asperity structure formed on the adhering surface of the adhesive layer. One example of the method for forming an asperity structure on the adhering surface is described below. An adhesive layer containing a pressure-sensitive adhesive polymer and having a flat adhering surface is fixed on the back surface of a support. Onto the adhering surface of the adhesive layer, a liner having a predetermined asperity structure is impressed to transfer the asperity structure (negative structure) of the liner to the adhering surface and thereby form a predetermined asperity structure (positive structure) on the adhering surface.

The adhesive layer usually contains a pressure-sensitive adhesive polymer and immediately after peeling off the impressed liner and adhering the sheet to an adherend, the asperity structure can be maintained. Therefore, when the adhesive sheet is adhered to an adherend, the adhesive layer can be prevented from firmly adhering and thereby, re-peeling for adjusting the position or escaping of bubbles involved between the adherend and the adhesive layer can be facilitated. The adhesive layer is preferably formed by coating a composition containing a pressure-sensitive adhesive polymer and a cross-linking agent.

The adhesive sheet can also be formed by coating a composition containing a pressure-sensitive adhesive polymer on the asperity surface of the release liner having a negative asperity structure to form an adhesive layer, stacking this adhesive layer with the liner on a support and fixing them to each other. When the liner is peeled off from the thus-formed adhesive sheet, an adhering surface having a positive asperity structure resulting from the transfer of the negative structure of the liner comes out. In the adhesive layer formed by such method, the cross-linked pressure-sensitive adhesive polymer remains a given asperity structure, a deformation of the asperity structure is prevented effectively, and a field water resistance is increased.

Out of the dimensions of the asperity structure formed on the adhering surface, the groove depth and the thickness of the adhesive layer as a whole may be set as described above. Other dimensions, for example, the maximum width of the groove (namely, the maximum distance between adjacent convex portions) is usually from 20 to 500 μm, preferably from 40 to 200 μm, more preferably from 50 to 100 μm. The maximum width (maximum horizontal dimension) of the convex portion defining the groove is usually from 0.1 to 10 mm.

With respect to the disposition of convex portions on the adhering surface, regular disposition is preferred. For example, the convex portion is disposed almost at the center of each square (nearly regular square) in a cross-cut geometric pattern. In this case, grooves are formed along lines configuring the squares and at least one groove, preferably a plurality of grooves, can communicate with the exterior in the outer peripheral edge of the image recording medium adhered to an adherend, thereby ensuring an opening.

The adhesive layer is preferably formed of a composition containing 100 parts by weight of a pressure-sensitive adhesive polymer and from 0.01 to 5 parts by weight of a cross-linking agent. The term “pressure-sensitive adhesive polymer” as used in the present invention means a polymer which shows tackiness at an ordinary temperature and can be used as a pressure-sensitive adhesive. Examples of such a polymer which can be used include acrylic polymers, polyurethane, polyolefin and polyester. Similarly to conventionally known pressure-sensitive adhesives, a tackifier can be also be used in combination with the pressure-sensitive adhesive polymer.

The pressure-sensitive adhesive polymer preferably has active hydrogen within the molecule so as to increase the water absorptivity of the adhesive layer. The active hydrogen readily forms a hydrogen bond with a water molecule, therefore, can effectively increase the water absorptivity of the adhesive layer. Suitable examples of the functional group having active hydrogen include a carboxyl group, a hydroxy group and an amino group. The active hydrogen can be integrated into the molecule as an active hydrogen-containing group (functional group). For introducing the active hydrogen-containing group into a polymer, the polymer is preferably synthesized from a starting material containing a first monomer having an active hydrogen-containing group within the molecule and a second monomer copolymerizable with the first polymer.

This synthesis is described by taking an acrylic polymer as an example. First, an acrylic unsaturated acid (e.g., acrylic acid, methacrylic acid, itaconic acid, maleic acid) is prepared as the first monomer. This first monomer and an acryl monomer as the second monomer are mixed to prepare a monomer mixture. As the second comonomer, an alkyl acrylate such as isooctyl acrylate, butyl acrylate, 2-ethylhexyl acrylate and isononyl acrylate, may be used. The mass ratio between the first monomer and the second monomer contained in the monomer mixture is preferably from 1:99 to 10:90.

From the thus-prepared monomer mixture, a pressure-sensitive adhesive polymer having a predetermined molecular weight is synthesized using a usual polymerization method such as solution polymerization, emulsion polymerization and block polymerization. The molecular weight of the pressure-sensitive adhesive polymer may be sufficient if predetermined tackiness can be exerted and it is usually, in terms of the weight average molecular weight, from 10,000 to 100,000.

The pressure-sensitive adhesive polymer may also be cross-linked. In the cross-linking, a cross-linking agent comprising, for example, an isocyanate compound, a melamine compound, a poly(meth)acrylate compound, an epoxy compound or an amido compound may be added. Also in the case where the pressure-sensitive adhesive layer contains a pressure-insensitive adhesive polymer, the polymer may be cross-linked using the above-described cross-linking agent.

The compressive modulus of the adhesive layer is preferably from 1×10³ to 1×10⁵ Pa (from 1×10⁴ to 1×10⁶ dyne/cm²). If the compressive modulus is too low, it is difficult to increase a field water resistance, and if the compressive modulus is too high, an adhesive strength may decrease, the recording medium cannot be used for a long term in a field. The “compressive modulus” is a compressive modulus measured at 20° C. using a viscoelasticity spectrometer RSAII manufactured by Rheometrix Corporation. More specifically, while imposing compressive distortion at a frequency of 1 rad/sec, the temperature is changed within the range of from −80° C. to 150° C. and the temperature dependency of the elastic modulus is measured. The measured value at 20° C. is defined as the compressive modulus.

Respective constituent factors of the image recording medium of the present invention and the combination of respective constituent factors are preferably determined so as not to cause appearance defective due to swelling in the field water resistance test or in the following water resistance accelerated test. The water resistance accelerated test is a cycle test where an image recording medium specimen having a plane dimension of 70 mm×150 mm is prepared, adhered onto the surface of an aluminum sheet by twice reciprocating a pressurizing roller having a weight of 2 kg and allowed to stand at room temperature for 24 hours, thereafter, the specimen is repeatedly cured under heating at 65° C. and dipped in warm water at 40° C.

*Cycle Conditions:

heating at 65° C. for 24 hours→dipping in warm water at 40° C. for 24 hours→heating at 65° C. for 24 hours→dipping in warm water at 40° C. for 24 hours→heating at 65° C. for 24 hours→dipping in warm water at 40° C. for 24 hours→heating at 65° C. for 24 hours→dipping in warm water at 40° C. for 24 hours→heating at 65° C. for 24 hours→dipping in warm water at 40° C. for 24 hours.

The image recording medium of the present invention is used for recording an ink image by a printing apparatus such as ink jet printer. When the above-described ink-receptive layer is provided and at the same time the support is hydrophilized, the recording medium of the present invention exhibits the effects particularly in the recording by an ink jet printer using aqueous ink (namely, water is the solvent) and both the fast drying property and the water resistance can be effectively increased. The ink usually contains a coloring agent such as pigment, and a solvent such as water. The printing may be performed under the same conditions as in the printing on normal recording paper.

The image recording medium of the present invention can be used as a decorative adhesive sheet. For example, a laminate comprising the image recording medium with a liner is prepared, the laminate is set to a printer, and a decorative printing is applied to the ink-receptive surface of the recording medium to manufacture a decorative adhesive sheet. Similarly to the normal decorative adhesive sheet, the adhesive sheet according to the present invention can be adhered onto the surface of an adherend such as sign-board, wall, vehicle body or glass window, and thereby decorate the adherend.

### EXAMPLES

### Example 1

An amorphous silica-containing porous film ((trademark) Teslin produced by PPG Industry K.K.) having a porosity of 65 vol %, a thickness of 180 μm and a pore size of from 0.01 to 1 μm was prepared as the support. On one surface of this support, an adhesive layer with a liner was stacked. The adhesive layer with a liner was prepared as follows. A liner having a predetermined asperity structure was prepared and a pressure-sensitive adhesive containing an acrylic pressure-sensitive adhesive polymer was coated on the asperity structure surface to form an adhesive layer having a thickness (T) of 25 μm. The acrylic pressure-sensitive adhesive polymer contained within the molecule a carboxyl group-containing functional group comprising an acrylic acid residue. The asperity structure of the liner was constructed such that convex portions being a plurality of protrusions corresponding to grooves formed on the adhesive layer were continuously disposed along the lines configuring squares to intersect with each other. The protrusion had a height of 19.5 μm and the adhesive layer had a groove depth D of 19.5 μm. Accordingly, the dimension T−D was 5.5 μm. In the liner, the maximum distance between adjacent protrusions (namely, distance between protrusion bottom surfaces) was 1.2 mm and the width of the protrusion was 55 μm. The vertical cross section of the protrusion was nearly trapezoidal and in correspondence thereto, the groove of the adhesive layer had a vertical cross section nearly in the trapezoidal shape.

On another surface of the thus-obtained support with an adhesive layer, a surfactant-containing solution having the following composition was coated using a bar coater and then dried, thereby hydrophilizing the'surface.

Composition of Hydrophilizing Solution

| | |
|---|---|
| Surfactant ((trademark) PELEX (lot) TR produced by | 13 parts by mass |
| Kao Corporation) | |
| Deionized water | 61 parts by mass |
| Ethanol | 26 parts by mass |

Finally, on the hydrophilized another side of the support, a coating solution having the following composition was coated using a bar coater and then dried to form an ink-receptive layer, thereby obtaining an image recording medium of this Example. The drying of the coated layer was performed under the conditions of 100° C. and 3 minutes and the thickness of the receptive layer was 20 μm.

Composition No. 1 of Coating Solution for Forming Receptive Layer

| | |
|---|---|
| (trademark) PATERACOL (lot) IJ-170 | 95 parts by mass |
| Aqueous solution of aluminum sulfate tetradeca- to | 5 parts by weight |
| octadeca-hydrate | |

The (trademark) PATERACOL (lot) U-170 is a coating agent containing cation-modified polyurethane and inorganic fine powder and available from Dai-Nippon Ink & Chemicals, Inc.

On the surface (ink-receptive surface) of the ink-receptive layer of the recording medium of this Example, an ink image was formed by printing it using an ink jet printer (trademark) Navajet (lot) III manufactured by Encad K. K. and the following printing properties were evaluated. The printing conditions are shown together below.

Printing Conditions

Printing direction: single direction

Ink jetting rate: 5,000 Hz

Ink used: Four colors of pigmented inks produced by 3M, (lot) 8550 series, namely, cyan (#8551), magenta (#8553), yellow (#8552) and block (#8554) were used.

Printing Properties

(1) Dry Time:

This was evaluated by the dry time (a time until the ink lost the gloss which can be observed by an eye) of the portion having full mixing of 4 color inks (400% area). The dry time was 75 seconds and the fast drying property was sufficiently high.

(2) Blur:

The blur at the boundary between the portion having mixing of 3 color inks except for black (300% area) and other color portion adjacent thereto was observed by an eye and evaluated. Almost no blur was observed.

(3) Coloring Property (Color Density)

The coloring property (observed by an eye) was very high both in individual color portions and in the mixed color portion.

Printing was performed by changing the printer to an ink jet printer (lot) BJC-600J manufactured by Canon K. K.) and the printing properties were evaluated. The drying of the 400% area was completed when the sheet came out from the printer and almost no blur was observed at the boundary of the 300% area. The coloring property was also very high.

A recorded image recording medium was prepared by forming an image using a printer (trademark) Navajet (lot) III in the same manner as above and then adhering thereto a transparent over-laminate film (lot) #8516 produced by 3M to cover the image surface.

This recorded medium was adhered to an aluminum sheet through the adhesive layer of the medium by twice reciprocating a pressurizing roller having a weight of 2 kg, left standing at room temperature for 24 hours and then subjected to the cycle test (repetition of curing under heating at 65° C. and dipping in warm water at 40° C.) described above. After the test, the image surface of the recorded medium was observed from the over-laminate film side, then swelling was not generated at all.

Separately, a non-recorded image recording medium was adhered to an aluminum sheet by twice reciprocating a pressurizing roller having a weight of 2 kg, left standing at room temperature for 24 hours and then examined whether or not the asperity pattern of the adhesive layer was viewed from the ink-receptive surface side. As a result, the asperity pattern was not viewed.

### Comparative Example 1

A recorded image recording medium was manufactured in the same manner as in Example 1 except for changing the height of the convex portion of the liner to 15 μm. A cycle test was performed in the same manner as in Example 1, as a result, swelling was generated between the over-laminate film and the image surface and the appearance was judged defective.

### Comparative Example 2

A recorded image recording medium was manufactured in the same manner as in Example 1 except for changing the thickness of the adhesive layer to 31 μm and the dimensional difference T−D to 11.5 mm. A cycle test was performed in the same manner as in Example 1, as a result, swelling was generated between the overlaminate film and the image surface and the appearance was judged defective.

### Example 2

A recorded image recording medium was manufactured in the same manner as in Example 1 except for changing the thickness of the adhesive layer to 20 μm and the dimensional difference T−D to 0.5 mm. A cycle test was performed in the same manner as in Example 1, as a result, generation of very slight swelling was observed between the over-laminate film and the image surface but the degree thereof was as low as causing no appearance defective.

Also, the medium was examined whether or not the asperity pattern of the adhesive layer was viewed from the ink-receptive surface side in the same manner as in Example 1. As a result, the asperity pattern was clearly viewed.

Effects of the Invention

According to the image recording medium of the present invention, the residence of water imbibed into the interface of respective stacked layers inside the medium can be effectively prevented and thereby generation of swelling due to water or vaporized water can be effectively prevented, during use particularly even on use outdoors.

What is claimed is:

1. An image recording medium comprising:
a support having two major surfaces,
an ink-receptive layer disposed on the first major surface of said support, and
an adhesive layer disposed on the second major surface of said support,
wherein the support is a porous body having gas permeable fine pores,
a plurality of grooves capable of communicating with the exterior upon contacting with an adherend are provided on the adhering surface of said adhesive layer, the adhering surface being a surface opposite the surface contacting with the support and put into contact with the adherend, and
said grooves satisfy the relationship between the depth D (μm) measured from the adhering surface and the thickness T (μm) of the adhesive layer, represented by the following formula:
0≦T−D≦10, provided that D≧16 μm.

2. The image recording medium as claimed in claim 1, wherein said adhesive layer contains a pressure-sensitive adhesive polymer having active hydrogen within the molecule.

3. The image recording medium as claimed in claim 1 or 2, wherein the thickness T of said adhesive layer is from 20 to 40 μm.
